(19) United States
(12) Patent Application Publication
(10) Pub. No.: US 2024/0318489 A1
(43) Pub. Date: Sep. 26, 2024

(54) VEHICLE

(71) Applicant: TOYOTA JIDOSHA KABUSHIKI KAISHA, Toyota-shi (JP)

(72) Inventor: Masatoshi HAYASHI, Nisshin-shi (JP)

(73) Assignee: TOYOTA JIDOSHA KABUSHIKI KAISHA, Toyota-shi (JP)

(21) Appl. No.: 18/431,034

(22) Filed: Feb. 2, 2024

(30) Foreign Application Priority Data
Mar. 23, 2023 (JP) 2023-046380

(51) Int. Cl. E05F 5/06; B60Q 9/00

(52) U.S. Cl. CPC E05F 5/06; B60Q 9/00; E05Y 2400/20; E05Y 2400/44; E05Y 2900/531

(57) ABSTRACT

The ECU executes processes including the steps of determining whether the vehicle is to stop; when it is determined that the vehicle is to stop, determining whether there is a door opening operation; and when it is determined that there is a door opening operation. A step of determining whether the air volume is larger than a threshold value, a step of notifying a warning when the air volume is larger than the threshold value, and a step of restricting the movement of the door in the opening direction.

### CROSS-REFERENCE TO RELATED APPLICATION

This application claims priority to Japanese Patent Application No. 2023-046380 filed on Mar. 23, 2023, incorporated herein by reference in its entirety.

### BACKGROUND

### 1. Technical Field

The present disclosure relates to a vehicle.

### 2. Description of Related Art

In a case where a boarding and alighting door of a vehicle is opened and closed, the force of the wind may act on the door if the wind is strong. To solve this problem, Japanese Unexamined Patent Application Publication No. 2017-149246 (JP 2017-149246 A) discloses a technique for suppressing the door from closing due to the force of the wind by increasing the damping force of the door, when the door is open, the wind direction is in the closing direction of the door, and the wind speed is higher than a predetermined value.

### SUMMARY

In the vehicle described above, for example, when the wind blows from the rear side of the vehicle, and the user opens the closed door of the vehicle, the force of the wind acts on the door, the door opening amount is equal to or more than the amount intended by the user, and there is a possibility that the door may come into contact with an obstacle (for example, an adjacent vehicle or a wall) that is present within the movable range of the door.

The present disclosure has been made in order to solve the above issue, and an object of the present disclosure is to provide a vehicle that suppresses the boarding and alighting door from coming into contact with an obstacle that is present within the movable range of the door due to the wind.

A vehicle according to an aspect of the present disclosure includes:

an air volume detection device that detects an air volume of wind blowing in a direction in which a door of the vehicle opens;
a notification device that notifies an occupant of the vehicle of predetermined information; and
a control device that controls an operation of the notification device, in which
the control device notifies the occupant of opening movement of the door of the vehicle using the notification device when the air volume detected using the air volume detection device exceeds a threshold, after the vehicle has stopped.

As described above, when the air volume exceeds the threshold, the warning information about the door opening movement is notified to the occupant using the notification device. This can prompt the occupant to take careful action when opening the door. Therefore, even when the occupant performs an operation for opening the door of the vehicle, it is possible to suppress the force of the wind from acting on the opened door and the door opening amount from becoming equal to or more than the amount intended by the user.

In an embodiment, the vehicle further includes

an operation detection device that detects an opening operation for opening the door, and a restriction device that restricts movement of the door in an opening direction.
The control device controls the restriction device such that the restriction device restricts the movement of the door in the opening direction when the air volume exceeds the threshold and the opening operation is detected, after the vehicle has stopped.

As described above, when the air volume exceeds the threshold, and the operation for opening the door of the vehicle is detected, the restriction device restricts the movement of the door in the opening direction, so that it is possible to suppress the door opening amount from becoming equal to or more than the amount intended by the user even when the force of the wind acts on the door.

Further, in an embodiment, the control device increases a restriction amount for restricting the movement of the door in the opening direction when the air volume is large as compared with a case where the air volume is small.

As described above, even when the force acting on the door due to the wind increases when the air volume is large, it is possible to suppress the door opening amount in the door opening direction from becoming equal to ore more than the amount intended by the user.

According to the present disclosure, it is possible to provide a vehicle that suppresses the boarding and alighting door from coming into contact with an obstacle that is present within the movable range of the door due to the wind.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing an example of the overall configuration of a vehicle according to the present embodiment; and

FIG. 2 is a flowchart showing an example of processing executed by the ECU.

### DETAILED DESCRIPTION OF EMBODIMENTS

Hereinafter, an embodiment of the present disclosure will be described in detail with reference to the drawings. In the drawings, the same or corresponding portions are denoted by the same reference signs and the description thereof will not be repeated.

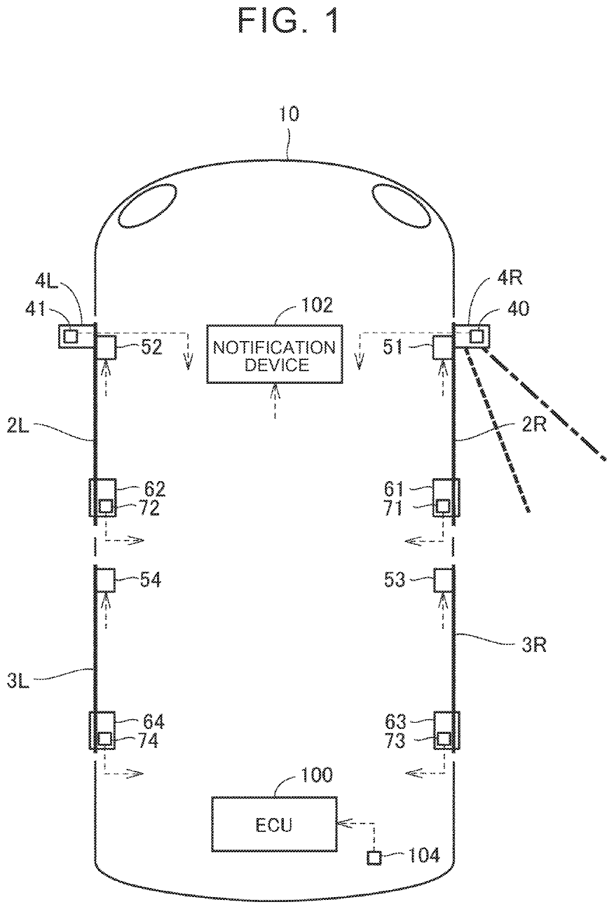

FIG. 1 is a diagram schematically showing an example of the overall configuration of a vehicle 10 according to the present embodiment. In the present embodiment, the vehicle 10 may be, for example, a vehicle that uses an engine as a driving source, a battery electric vehicle that uses an electric motor as a driving source, or is equipped with an engine and an electric motor, and at least It may also be a hybrid electric vehicle using either of these as a driving source.

As shown in FIG. 1, the vehicle 10 includes a right front door 2R, a left front door 2L, a right rear door 3R, a left rear door 3L, a right door mirror 4R, a left door mirror 4L, and a first air volume sensor 40. The second air volume sensor 41, the first actuator 51, the second actuator 52, the third actuator 53, the fourth actuator 54, the first door operating unit 61, the second door operating unit 62, and the third door operating unit 63, the fourth door operating unit 64, the first switch 71, the second switch 72, the third switch 73, the fourth switch 74, the Electronic Control Unit (ECU) 100, and the notification device 102, and a vehicle speed sensor 104.

In FIG. 1, each of the right front door 2R, left front door 2L, right rear door 3R, and left rear door 3L, which are doors for getting on and off, is shown in a closed state (closed state). Hereinafter, the closed state may be referred to as the initial state.

A right front door 2R and a right rear door 3R are provided on the right side of the vehicle 10 along the traveling direction of the vehicle 10. A left front door 2L and a left rear door 3L are provided on the left side of the vehicle 10 along the traveling direction of the vehicle.

The right front door 2R rotates around a hinge (not shown) provided at the front end of the vehicle 10 of the right front door 2R, as shown in the thick broken line in FIG. 1 and the dashed-dotted line in FIG. 1. In addition, an end portion of the right front door 2R on the rear side of the vehicle 10 is configured to rotate clockwise when viewed from the top surface of the vehicle 10. When the right front door 2R is in the closed state, movement of the end of the right front door 2R on the rear side of the vehicle 10 is restrained by a lock mechanism (not shown).

A first door operating unit 61 is provided on the right front door 2R. The first door operating unit 61 includes, for example, a door handle that can be operated from the outside of the vehicle 10 and a door handle that can be operated from the inside of the vehicle 10 (both not shown). When a predetermined operation is performed on the first door operating unit 61 from the outside or inside of the vehicle 10, the right front door 2R is released from the locking mechanism and can be manually rotated from the initial state to the open side.

The first door operating unit 61 is provided with a first switch 71. The first switch 71 transmits an on signal to the ECU 100, for example, when the first door operating unit 61 is operated to open the right front door 2R. The first switch 71 does not output an on signal when the right front door 2R is in a closed state, and outputs an on signal when the right front door 2R is not in a closed state.

The left front door 2L and the second door operating unit 62 are provided at positions that are symmetrical to the right front door 2R and the first door operating unit 61, respectively, and the left front door 2L has a shape that is symmetrical to the right front door 2R. The structure is the same as that of the right front door 2R and the first door operating unit 61, respectively, except for the following points. Therefore, detailed explanation thereof will not be repeated.

The second door operating unit 62 is provided with a second switch 72. The second switch 72 transmits an on signal to the ECU 100, for example, when the second door operating unit 62 is operated to open the left front door 2L. The second switch 72 does not output an on signal when the left front door 2L is in a closed state, and outputs an on signal when the left front door 2L is not in a closed state.

The right rear door 3R is configured such that the rear end of the vehicle 10 of the right rear door 3R rotates clockwise when viewed from the top of the vehicle 10 from an initial state with a hinge (not shown) provided at the front end of the vehicle 10 of the right rear door 3R as a center. When the right rear door 3R is in the closed state, movement of the end of the right rear door 3R on the rear side of the vehicle 10 is restrained by a lock mechanism (not shown).

A third door operating unit 63 is provided on the right rear door 3R. The third door operating unit 63 includes, for example, a door handle that can be operated from the outside of the vehicle 10 and a door handle that can be operated from the inside of the vehicle 10 (both not shown). When a predetermined operation is performed on the third door operating unit 63 from the outside or inside of the vehicle 10, the right rear door 3R is released from the locking mechanism and can be manually rotated from the initial state to the open side.

The third door operating unit 63 is provided with a third switch 73. The third switch 73 transmits an on signal to the ECU 100, for example, when the third door operating unit 63 is operated to open the right rear door 3R. The third switch 73 does not output an on signal when the right rear door 3R is in a closed state, and outputs an on signal when the right rear door 3R is not in a closed state.

The left rear door 3L and the fourth door operating unit 64 are provided at positions symmetrical to the right rear door 3R and the third door operating unit 63, respectively, and the left rear door 3L is symmetrical to the right rear door 3R. The configuration is the same as that of the right rear door 3R and the third door operating unit 63 except for the shape. Therefore, detailed explanation thereof will not be repeated.

The fourth door operating unit 64 is provided with a fourth switch 74. The fourth switch 74 transmits an on signal to the ECU 100, for example, when the fourth door operating unit 64 is operated to open the left rear door 3L. The fourth switch 74 does not output an on signal when the left rear door 3L is in a closed state, and outputs an on signal when the left rear door 3L is not in a closed state.

A right door mirror 4R is provided above the vehicle 10 from the hinge at the end of the right front door 2R on the front side of the vehicle 10. The right door mirror 4R is provided with a first air volume sensor 40 in addition to a mirror portion (not shown). The first air volume sensor 40 detects the volume of wind blowing from the rear right side of the vehicle 10. The first air volume sensor 40 transmits a signal indicating the detected air volume to the ECU 100.

A left door mirror 4L is provided above the vehicle 10 from the hinge at the end of the left front door 2L on the front side of the vehicle 10. The left door mirror 4L is provided with a second air volume sensor 41 in addition to a mirror portion (not shown). The second air volume sensor 41 detects the volume of wind blowing from the rear left side of the vehicle 10. The second air volume sensor 41 transmits a signal indicating the detected air volume to the ECU 100.

Further, in this embodiment, a first actuator 51 is provided at a rotating portion (for example, a hinge portion) of the right front door 2R. The first actuator 51 sets, for example, a stopper that limits the movable range of the right front door 2R within the rotation range of the right front door 2R (for example, within the movable range of the hinge portion), or cancels the setting of the stopper. Note that the first actuator 51 may have any configuration as long as it can limit the rotation of the right front door 2R, and may have a configuration in which an electric motor sets or cancels the setting of a stopper, or a hydraulic cylinder or the like sets the stopper. Alternatively, the configuration may be such that the setting is canceled. This actuator and stopper constitute a “restriction device”.

A second actuator 52, a third actuator 53, and a fourth actuator 54 are also provided at the rotating parts of the left front door 2L, right rear door 3R, and left rear door 3L, respectively. The functions and operations of each are similar to those of the first actuator 51, so detailed description thereof will not be repeated. The first actuator 51, the second actuator 52, the third actuator 53, and the fourth actuator 54 are all driven according to control signals from the ECU 100.

ECU 100 is a computer that includes a processor such as a CPU that executes a program, memory, and an input/output interface. ECU 100 includes various control programs for controlling various actuators installed in vehicle 10. In this embodiment, the various control programs further include a control program for controlling the first actuator 51, the second actuator 52, the third actuator 53, and the fourth actuator 54. A notification device 102 and a vehicle speed sensor 104 are connected to the ECU 100.

The notification device 102 is configured with a display unit such as a touch panel display, for example, and displays a warning light, an image, text information, etc. on the display unit in response to a control signal from the ECU 100. Further, the notification device 102 may include, for example, a sound generating device that generates a sound, an alarm, a warning sound, etc. in addition to the display on the display unit.

Vehicle speed sensor 104 detects the speed of vehicle 10 (vehicle speed). Vehicle speed sensor 104 transmits a signal indicating the detected vehicle speed to ECU 100.

In the vehicle 10 having the above configuration, when the wind blows from the rear side of the vehicle 10, when the user opens any door of the vehicle 10, the force of the wind blows the amount intended by the user. If the door opens further than this, there is a possibility that the door may come into contact with an obstacle (for example, an adjacent vehicle or a wall) within the range of movement of the door.

Therefore, in the present embodiment, when the air volume detected using at least one of the first air volume sensor 40 and the second air volume sensor 41 exceeds a threshold value after the vehicle 10 has stopped, the ECU 100 Assume that the notification device 102 is used to notify a user, who is a passenger, of warning information regarding the door opening operation.

In this way, warning information about the door opening operation is notified to the user using the notification device 102, so that the user can be urged to act cautiously when opening the door.

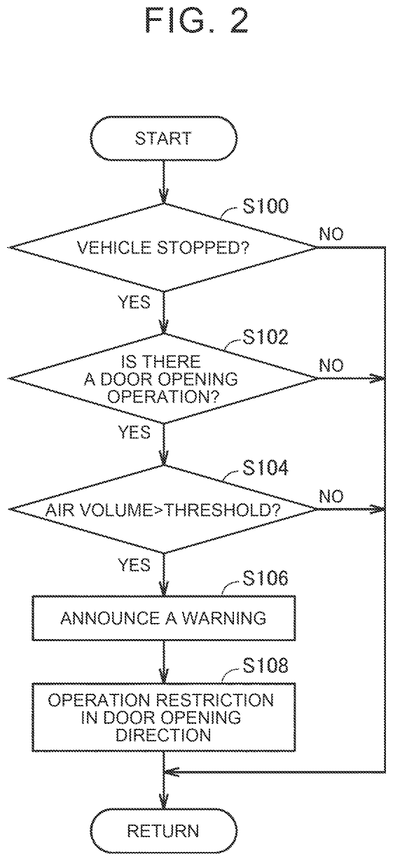

An example of processing executed by ECU 100 will be described below. FIG. 2 is a flowchart illustrating an example of a process executed by ECU 100. A series of processes shown in this flowchart are repeatedly executed in ECU 100 at predetermined intervals.

At step (hereinafter referred to as S) 100, ECU 100 determines whether vehicle 10 is stopped. ECU 100 determines that vehicle 10 is stopped, for example, when the vehicle speed detected using vehicle speed sensor 104 is less than or equal to a threshold value (for example, zero) for determining a stopped state. If it is determined that the vehicle 10 is stopped (YES in S100), the process moves to S102.

In S102, ECU 100 determines whether there is a door opening operation. For example, the ECU 100 determines that a door opening operation is performed when receiving an ON signal from at least one of the first switch 71, the second switch 72, the third switch 73, and the fourth switch 74. If it is determined that there is an operation to open the door (YES in S102), the process moves to S104.

In S104, ECU 100 determines whether the air volume is larger than a threshold value. For example, when an opening operation is performed on the right front door 2R or the right rear door 3R (when an ON signal is received from the first switch 71 or the third switch 73), the ECU 100 transmits the detection result of the first air volume sensor 40, is used to determine whether the air volume is greater than a threshold value. Alternatively, for example, when an opening operation is performed on the left front door 2L or the left rear door 3L (when an ON signal is received from the second switch 72 or the fourth switch 74), the ECU 100 detects the second air volume sensor 41, and determines whether the air volume is greater than a threshold. The threshold value is set, for example, by experimenting with an air volume that is sufficient to apply a force that causes the door to rotate open. If it is determined that the air volume is larger than the threshold value (YES in S104), the process moves to S106.

At S106, ECU 100 issues a warning. For example, the ECU 100 may cause the display unit of the notification device 102 to display text information or image information indicating that the door may open more than intended due to wind. Alternatively, the ECU 100 may cause the display unit of the notification device 102 to display, for example, text information or image information indicating that the wind blowing outside the vehicle is strong. Alternatively, the ECU 100 may cause the display unit of the notification device 102 to display text information or image information indicating that caution is required in opening the door. The process then moves to S108.

At S108, ECU 100 limits the operation of the door in the opening direction. Specifically, the ECU 100 controls the actuator to limit the movement in the opening direction of the door on which the opening operation has been performed. The ECU 100 limits the directional movement of opening the door by driving the actuator corresponding to the switch that outputs an on signal among the first switch 71 to the fourth switch 74, and setting a stopper that limits the rotation range of the door to a certain amount. The process is then terminated.

Note that this process is terminated when the vehicle is not stopped (NO at S100), there is no door opening operation (NO at S102), or the air volume is below the threshold (NO at S104).

The operation of ECU 100 of vehicle 10 according to the present embodiment will be described based on the structure and flowchart as described above.

For example, assume that the various doors of the stopped vehicle 10 are all closed, as shown in FIG. 1. It is assumed that a user is riding in the vehicle 10, for example, in the driver's seat (front right seat).

While the vehicle 10 is stopped (YES in S100), when the user sitting in the right front seat of the vehicle 10 operates the first door operating unit 61 to open the right front door 2R (YES in S102), it is determined whether the air volume is larger than a threshold value using the detection result of the first air volume sensor 40 (S104). If it is determined that the air volume is larger than the threshold value (YES in S104), a warning is issued using the notification device 102 (S106). Thereby, the user can recognize that when opening the right front door 2R, there is a possibility that the right front door 2R may be opened more than intended. Therefore, the user can prevent the right front door 2R from coming into contact with obstacles within the movable range by delaying the opening operation of the right front door 2R or carefully rotating the right front door 2R.

Then, the operation in the opening direction of the right front door 2R corresponding to the first door operating unit 61 on which the opening operation was performed is restricted (S106). Therefore, even if the user rotates the right front door 2R, the rotation range is limited by the stopper, so that it is prevented from opening more than the intended amount. Therefore, the right front door 2R is reliably suppressed from coming into contact with obstacles within its movable range.

As described above, according to the vehicle 10 according to the present embodiment, warning information regarding the door opening operation is notified to the user using the notification device 102, so that the door opening operation can be performed. can encourage careful behavior. Therefore, it is possible to provide a vehicle that suppresses contact with obstacles within the movable range of the entrance/exit door.

Further, after the vehicle 10 has stopped, if the air volume exceeds the threshold and an operation to open the door of the vehicle 10 is detected, the actuator is controlled to limit the operation in the opening direction of the door. Therefore, when the air volume exceeds the threshold and an operation to open the door of the vehicle 10 is detected, the movement of the door in the opening direction is restricted by the stopper, so that it is also possible to reliably suppress the door from opening more than the amount intended by the user in the opening direction even though the force due to the wind is applied to the door.

Hereinafter, modifications will be described.

In the embodiment described above, the case where the rotation range of the door is limited by driving the actuator and setting the stopper when the air volume exceeds the threshold value has been described as an example, but when the actuator is an electric motor Alternatively, the actuator may be driven to generate a resistance torque in the direction of rotation of the hinge portion. At this time, the actuator realizes a “restriction device”.

In this case, the ECU 100 may control the actuator so that a predetermined resistance torque is generated in the rotation direction when opening the door, or the ECU 100 may control the actuator so that the resistance torque generated changes depending on the air volume. Note that the resistance torque corresponds to “the amount of restriction that limits the movement of the door in the opening direction.”

For example, when the air volume detected by at least one of the first air volume sensor 40 and the second air volume sensor 41 is large, the ECU 100 increases the resistance torque in the rotation direction more than when the air volume is small. For example, the ECU 100 controls the actuator to increase the resistance torque when the air volume is at least a first value larger than the threshold value than when it is larger than the threshold value and smaller than the first value, may be controlled. Further, while the ECU 100 is executing the control that restricts the operation in the opening direction of the door, the ECU 100 may use the notification device 102 to notify information indicating that the control is being executed.

In this way, even if a force due to a large amount of air acts on the door, it is possible to suppress the door from opening more than the amount intended by the user.

Furthermore, in the above-described embodiment, the case where the first air volume sensor 40 and the second air volume sensor 41 are provided in the right door mirror 4R and the left door mirror 4L is described as an example, but the amount of air blowing in the direction in which the door of the vehicle 10 opens is It is sufficient as long as it can be detected, and it is not particularly limited to being provided on the door mirror. For example, the airflow sensor may be provided on the roof, rear gate, trunk, etc. of the vehicle 10.

Furthermore, in the above-described embodiment, the user who opens the door is notified of a warning using the notification device 102, but the user is continuously warned while the opening operation continues, etc. may be notified.

Further, in the above embodiment, the air volume sensor is used to detect the volume of wind blowing from the rear side of the vehicle 10, but the air volume sensor only needs to be able to detect at least the volume of wind blowing in the direction in which the door is opened, the direction of the detected wind may be set depending on the structure of the door to be opened, etc. For example, if the vehicle 10 has a door structure that opens at the front end, the amount of wind blowing from the front side of the vehicle 10 may be detected using an air volume sensor.

In addition, the above-mentioned modifications may be carried out by appropriately combining all or a part thereof.

The embodiment disclosed herein should be considered to be exemplary and not restrictive in all respects. The scope of the present disclosure is shown by the scope of claims rather than the description above, and is intended to include all modifications within the meaning and the scope equivalent to the scope of claims.

What is claimed is:

1. A vehicle comprising:
an air volume detection device that detects an air volume of wind blowing in a direction in which a door of the vehicle opens;
a notification device that notifies an occupant of the vehicle of predetermined information; and
a control device that controls an operation of the notification device, wherein the control device notifies the occupant of opening movement of the door of the vehicle using the notification device when the air volume detected using the air volume detection device exceeds a threshold, after the vehicle has stopped.

2. The vehicle according to claim 1, wherein:
the vehicle further includes
an operation detection device that detects an opening operation for opening the door, and
a restriction device that restricts movement of the door in an opening direction; and
the control device controls the restriction device such that the restriction device restricts the movement of the door in the opening direction when the air volume exceeds the threshold and the opening operation is detected, after the vehicle has stopped.

3. The vehicle according to claim 2, wherein the control device increases a restriction amount for restricting the movement of the door in the opening direction when the air volume is large as compared with a case where the air volume is small.
